(19) United States
(12) Patent Application Publication
(10) Pub. No.: US 2003/0198371 A1
(43) Pub. Date: Oct. 23, 2003

(54) Medical image processing apparatus, method and program with media in which the program is recorded

(76) Inventor: Youichi Ono, Tokyo (JP)

Correspondence Address: Squire, Sanders & Dempsey L.L.P., Suite 300, One Maritime Plaza, San Francisco, CA, 94111, US

(21) Appl. No.: 10/393,714

(22) Filed: Mar. 20, 2003

(30) Foreign Application Priority Data
Mar. 28, 2002 (JP) JP2002-092687

(51) Int. Cl. G06K 9/00

(52) U.S. Cl. 382/128

(57) ABSTRACT

A medical image processing apparatus, which is in a medical image processing system including plural output devices in a same network, for obtaining and image-processing a photographed medical image so as to output a processed image. The medical image processing apparatus includes: a storage for storing an image processing parameter corresponding to each photographic part of a medical image, to each of an operator and to each of output device; a discriminator for discriminating a photographic part of an obtained medical image, the operator and the output device; and an image processor for reading out the image processing parameter from the storage, corresponding to the photographic part, the operator and the output device, discriminated by the discriminator; in which the image processor performs image processing on the obtained medical image according to the image processing parameter so as to generate the processed image, and the image processor outputs the processed image to the output device.

### BACKGROUND OF THE INVENTION

The present invention relates to a medical image processing apparatus, medial image processing method and program thereof, and recording medium in which the program is recorded.

Recently, in the medical field, a medial image photographing apparatus such as an X ray photographing apparatus using a radioactive ray of an X ray, CT (Computed Tomography) apparatus, and MRI (Magnetic Resonance Imaging) apparatus, is used for the diagnosis. An image signal obtained by these medical image photographing apparatus is digital-converted to the image data by a medical image processing apparatus, and further, each kind of image data processing such as the frequency processing or gradation processing is conducted on it and it is outputted to a film or display device. The X ray image visualized in this manner, is used for the diagnosis such as the existence of a focus or bodily harm, or the grasp of the content.

The medial image processing apparatus digital-converts the image signal photographed by the X ray photographing apparatus into the monochromatic gradation image data, and further, each kind of image data processing such as the frequency processing or gradation processing is conducted on it, and the processed image data is outputted to the film, printer, or display apparatus. Further, the image processing apparatus digital-converts the image signal photographed by the CT apparatus or MRI apparatus, that is, the image signal in which the tomography of the human body is photographed, is digital-converted into the tomography data by the image processing and outputted to the printer or display device.

Further, in the conventional medical image processing apparatus, an image processing parameter is stored for each photographic part which is to be diagnosed, and an adequate image processing is conducted for each photographic part.

However, in the conventional medical image processing apparatus, because the image processing parameter is stored for each photographic part which is a diagnostic object, in a system to which a plurality of output devices are connected, in the case where the gradation characteristic or frequency characteristic of each output device is different, or a plurality of operators use the same image processing apparatus, when a plan of the image processing which is considered as optimum for each operator, is different, it is necessary that the setting of the processing parameter is conducted again, and there is a problem that the setting operation is troublesome.

The object of the present invention is to make the setting of the image processing parameter easy for each output device and for each operator.

### SUMMARY OF THE INVENTION

In order to solve the above problem, the present invention is characterized in that: in a medical image processing apparatus by which the photographed medical image is obtained and the image processing is conducted on it, and the processed image is outputted, there is provided with: a storing means for storing an image processing parameter corresponding to each photographic part of a medical image and for each output device for outputting the processed image; discriminating means for discriminating the photographic part of the obtained medical image and the output device of the output destination; and an image processing means by which the image processing parameter corresponding to the photographic part and the output device discriminated by the discriminating means is read from the storing means, and according to the image processing parameter, the image processing is conducted on the obtained medical image, and the processed image is outputted to the output device.

Further, the present invention is characterized in that: in a medical image processing method in a medical image processing apparatus by which a photographed medical image is obtained and the image processing is conducted on it, and the processed image is outputted, a process for storing an image processing parameter corresponding to each photographic part of a medical image and for each output device for outputting the processed image in the storing means; a process for discriminating the photographic part of the obtained medical image and the output device of the output destination; and a process by which the image processing parameter corresponding to the discriminated photographic part and the output device is read from the storing means, and according to the image processing parameter, the image processing is conducted on the obtained medical image, and the processed image is outputted to the output device, are included.

Further, the present invention is characterized in that: it is a program to make a computer to control a medical image processing apparatus by which the photographed medical image is obtained and the image processing is conducted on it, and the processed image is outputted, realize; a function to store the image processing parameter corresponding to each photographic part of the medical image and for each output device to output the processed image in a storing means; function to discriminate the photographic part of the obtained medical image and the output device of the output destination; and function by which the image processing parameter corresponding to the discriminated photographic part and output device is read, and according to the image processing parameter, the image processing is conducted on the obtained medical image, and the processed image is outputted to the output device.

Further, the present invention is characterized in that: in a recording medium in which a program which can be operated by a computer to control a medical image processing apparatus by which a photographed medical image is obtained and the image processing is conducted on it, and the processed image is outputted, is stored, a program including; a program code which can be operated by the computer for storing the image processing parameter corresponding to each photographic part of the medical image and for each output device to output the processed image in the storing means; program code which can be operated by a computer for discriminating the photographic part of the obtained medical image and the output device of the output destination; and program code which can be operated by a computer by which the image processing parameter corresponding to the discriminated photographic part and the output device is read from the storing means, and according to the image processing parameter, the image processing is conducted on the obtained medical image, and the processed image is outputted to the output device, is stored.

According to the present invention, the image processing parameter corresponding to each photographic part of the medical image and for each output device to output the processed image is stored in the storing means, the obtained photographic part of the medical image and the output device of the output destination are discriminated, and the image processing parameter corresponding to the discriminated photographic part and output device is read from the storing means, and according to the read image processing parameter, the image processing is conducted on the obtained medical image and it is outputted to the output device. Accordingly, in the case of a system to which a plurality of output devices are connected, it is not necessary that the image processing parameter is set again every when the image is outputted by the output device, and the image output operation becomes easy.

In an example of the present invention, the present invention is characterized in that: the storing means stores the image processing parameter for each photographic part of the medical image corresponding to the output device together with the image output characteristic of the output device whose output image is already confirmed; and the image processing means, when the processed image is outputted to the other output device which is different from the output device, corrects the image processing parameter stored in the storing means, adjusting to the image output characteristic of the other output device, and the image processing is conducted on the obtained medical image according to the corrected image processing parameter.

According to the present example, the image processing parameter for each photographic part of the medical image corresponding to the output device is stored in the storing means together with the image output characteristic of the output device whose output image is already confirmed, and when the processed image is outputted to the other output device which is different from the output device, the image processing parameter stored in the storing means is corrected adjusting to the image output characteristic of the other output device, and according to the corrected image processing parameter, the image processing is conducted on the obtained medical image. Accordingly, in the case of the system in which a plurality of output devices are connected, it is not necessary that the image processing parameter is set again every when the image is outputted by the output device, and the image output operation becomes easy. Furthermore, the capacity to store the processing parameter can be suppressed.

An example of the present invention is characterized in that: the storing means stores the standard image processing parameter for each photographic part of the medical image corresponding to the output device together with the image output characteristic of the standard output device; and the image processing means corrects the standard image processing parameter stored in the storing means adjusting to the image output characteristic of the output device outputting the image data when the processed image is outputted to the output device which is different from the standard output device, and according to the corrected image processing parameter, the image processing is conducted on the obtained medical image.

According to the present example, together with the image output characteristic of the standard output device, the standard image processing parameter for each photographic part of the medical image corresponding to the output device are stored in the storing means, and when the processed image is outputted to the output device which is different from the standard output device, the standard image processing parameter stored in the storing means is corrected adjusting to the image output characteristic of the outputting output device, and according to the corrected image processing parameter, the image processing is conducted on the obtained medical image. Accordingly, in the case of a system in which a plurality of output devices are connected, it is not necessary that the image processing parameter is set again every when the image is outputted by the output device, and the image output operation becomes easy. Furthermore, the capacity to store the image processing parameter can be suppressed, and in a plurality of medical image processing apparatus, the image processing parameter or characteristic information of each output device stored in the storing means can be owned in common.

An example of the present invention is characterized in that: in the medical image processing apparatus by which the photographed medical image is obtained, the image processing is conducted on it, and its processed image is outputted, there is provided with a storing means for storing the image processing parameter corresponding to each photographic part of the medical image and for each operator; a discrimination means for discriminating the photographic part of the obtained medical image and the operator; and an image processing means by which the image processing parameter corresponding to the photographic part and operator discriminated by the discrimination means is read from the storing means, and according to the image processing parameter, the image processing is conducted on the obtained medical image, and the processed image is outputted to the output device.

An example of the present invention is characterized in that: in a medical image processing method in the medical image processing apparatus by which the photographed medical image is obtained, the image processing is conducted on it, and its processed image is outputted, a process to store the image processing parameter corresponding to each photographic part of the medical image and for each operator in the storing means; a process to discriminate the photographic part of the obtained medical image and the operator; and a process in which the image processing parameter corresponding to the discriminated photographic part and operator is read from the storing means, the image processing is conducted on the obtained medical image according to the image processing parameter, and the processed image is outputted to the output device, are included.

An example of the present invention is characterized in that: it is a program to make the computer to control the medical image processing apparatus by which the photographed medical image is obtained and its processed image is outputted, realize: the function to store the image processing parameter corresponding to each photographic part of the medical image and for each operator in the storing means; the function to discriminate the photographic part of the obtained medical image and operator; and the function by which the image processing parameter corresponding to the discriminated photographic part and operator is read from the storing means, the image processing is conducted on the obtained medical image according to the image processing parameter, and the processed image is outputted to the output device.

An example of the present invention is characterized in that: in the storing medium in which a program which can be operated by the computer to control the medical image processing apparatus by which the photographed medical image is obtained and the image processing is conducted on it, and its processed image is outputted, is stored, a program is stored which includes: a program code which can be operated by the computer to store the image processing parameter corresponding to each photographic part of the medical image and for each operator in the storing means; a program code which can be operated by the computer to discriminate the photographic part of the obtained medical image and the operator; and a program code which can be operated by the computer by which the image processing parameter corresponding to the discriminated photographic part and operator is read from the storing means, the image processing is conducted on the obtained medical image according to the image processing parameter, and the processed image is outputted to the output device.

According to the above example, the image processing parameter corresponding to each photographic part of the medical image and for each operator is stored in the storing means, and the photographic part and the operator of the obtained medical image are discriminated, the image processing parameter corresponding to the discriminated photographic part and operator is read from the storing means, and the image processing is conducted on the obtained medical image according to the read image processing parameter, and it is outputted to the output device. Accordingly, even when a plurality of operators use the same output device, it is not necessary to be set again to the image processing parameter matched to a plan every when the image is outputted by the output device, and the image output operation becomes easy.

### BRIEF DESCRIPTION OF THE DRAWINGS

FIG. 1 is a view conceptually showing the overall structure of the present invention.

FIG. 2 is a block diagram showing the functional structure of a medical image processing apparatus 1 in FIG. 1.

FIG. 3 is a view showing an example of a data store inside a default parameter table 151 in FIG. 2.

FIG. 4 is a flowchart showing an image processing A conducted by a CPU 11 in FIG. 2.

FIG. 5 is a view showing an image output operation image plane 131 displayed on a display section 13 in FIG. 2.

FIG. 6 is a view showing an example of the data store inside a default parameter table 152.

FIG. 7 is a view showing an example of the data store inside an output device characteristic table 153.

FIG. 8 is a flowchart showing an image output processing B conducted by the CPU 11 in FIG. 2.

FIG. 9 is a view showing an example of the data store inside a default parameter table 154.

FIG. 10 is a flowchart showing an image output processing C conducted by the CPU 11 in FIG. 2.

FIG. 11 is a view showing an image output operation image plane 132 displayed on the display section 13 in FIG. 2.

FIG. 12 is a view showing an example of the data store inside a default parameter table 154.

### DETAILED DESCRIPTION OF THE INVENTION

Referring to drawings, the embodiment of the present invention will be detailed below.

In this connection, in the present embodiment, a CPU which will be described below, has a function as a discrimination means and an image processing means described in claims of the present invention, and a storing section 15 has a function as a storing means.

(The first Embodiment)

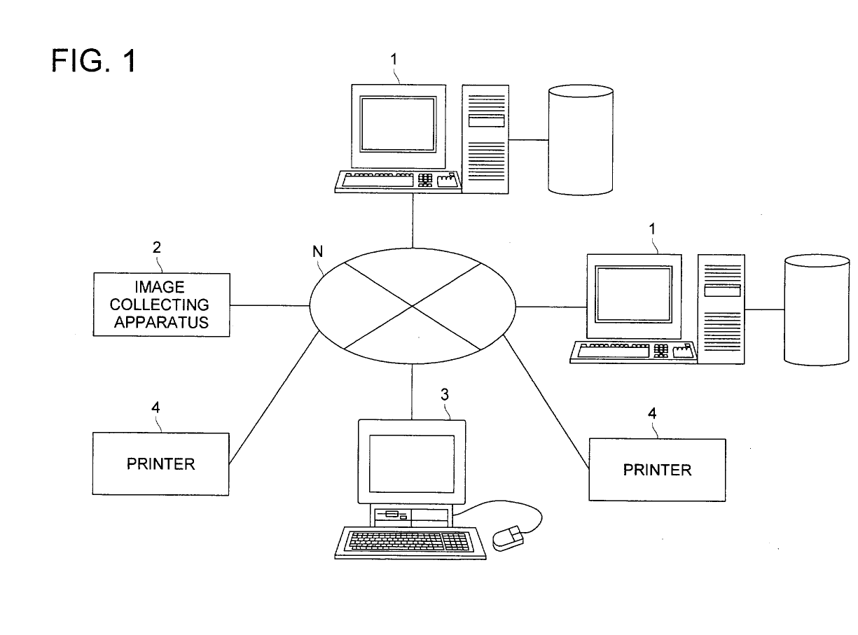

Initially, the structure will be explained. FIG. 1 is a view conceptually showing the overall structure of the present embodiment. As shown in FIG. 1, a medical image processing apparatus 1 is connected to an image collecting apparatus 2 to collect a medical image through a communication network such as LAN or internet. The connection to the communication network may also be a wire connection or wireless connection. The image collecting apparatus 2 is an X ray CT scanner, CR apparatus, ultrasonic diagnostic apparatus, or MRI (Magnetic Resonance Imaging) apparatus, and one set or a plurality of sets can be connected to a medical image processing apparatus 1. Thereby, the digital data of the medical image collected by the image collecting apparatus 2 is transmitted to the medical image processing apparatus 1 through the communication network N. In this connection, the image data collected by the image collecting apparatus 2 is stored in the storing media such as a memory, and the recording media is installed in the medical image processing apparatus 1, and the image data may also be obtained.

Further, the medical image processing apparatus 1 are connected in such a manner that the data con be transmitted and received through the communication network N such as the other medical image processing apparatus 1, image display apparatus 3, or printer 4, and this system is structured in such a manner that the information relating to the medical image such as the medical image data and comment which is transmitted from these external devices through the communication network N can be received and displayed, or the medical image information can be transmitted to the external device. The number of sets of these external devices are not particularly limited.

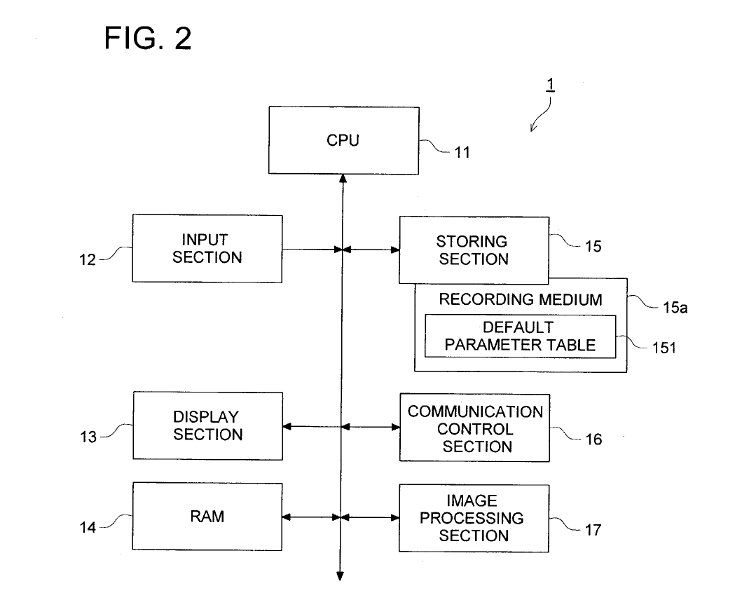

FIG. 2 is a block diagram showing the functional structure of the medical image processing apparatus 1. Referring to FIG. 2, the internal structure of the medical image processing apparatus 1 will be detailed below.

As shown in FIG. 2, the medical image processing apparatus 1 is structured by a CPU 11, input section 12, display section 13, RAM 14, storing section 15 having a recording medium 15a, communication control section 16, and image processing section 17, and each section is connected through a bus.

The CPU (Central Processing Unit) 11 reads each kind of control program stored in the storing section 15, and according to the control program, the movement of each section is centralized-controlled. Further, Further, the CPU 11 conducts each kind of processing including the image output processing A, image output processing B and image output processing C, which will be described later, according to the read control program, and stores the processing result in the RAM 14 and displays it on the display section 13. Then, the processing result stored in the RAM 14 is saved in a predetermined destination of the saving of the storing section 15 or recording medium 15a, or transmitted to the external devices connected to the communication network through the communication section 16.

The input section 12 is structured by providing with a keyboard having a character/alphanumeric input key, cursor key, and each kind of function key, and a mouse which is a pointing device, and the pressed signal of the key on the keyboard and the operation signal by the mouse are made an input signal, and outputted to the CPU 11. Alternatively, the input section 12 is structured by a touch panel which makes the position information inputted when the finger or exclusive use stylus pen touches the transparent sheet panel covering the display image plane of the display section 13, an input signal, and outputs it to the CPU 11.

The display section 13 is structured by a LCD (Liquid Crystal Display) or CRT (Cathode Ray Tube), and according to the direction of the display signal inputted from the CPU 11, it displays the image on the display image plane.

The RAN (Random Access Memory) 14 is a temporary storing area for the system program which is read from the storing section 15 and can be operated by the medical image processing apparatus 1, each kind of processing program, input or output data, and parameter, in each kind of processing which is operated and controlled by the CPU 11.

The storing section 15 is structured by a HD (Hard Disk) or nonvolatile semiconductor memory, and stores the system program corresponding to the medical image processing apparatus 1, and each kind of processing program which can be operated on the system program, and the data processed by these programs. The program is stored in the form of program code which can be read by the computer, and the CPU 11 successively conducts the movement according to the program code.

Further, the recording medium 15a is structured by a magnetic or optical recording medium, or nonvolatile memory such as a semiconductor, and stores each kind of data including the program data or the medical image data received from the image collecting apparatus 2, or the other medical image processing apparatus 1. The recording medium 15a is one which is fixedly provided in the storing section 15 or detachably installed. To the recording medium 15a, the data of the medical image and the information relating to the medical image data (patient name, photographic part) correspond, and they are stored in the medium as the medical image information.

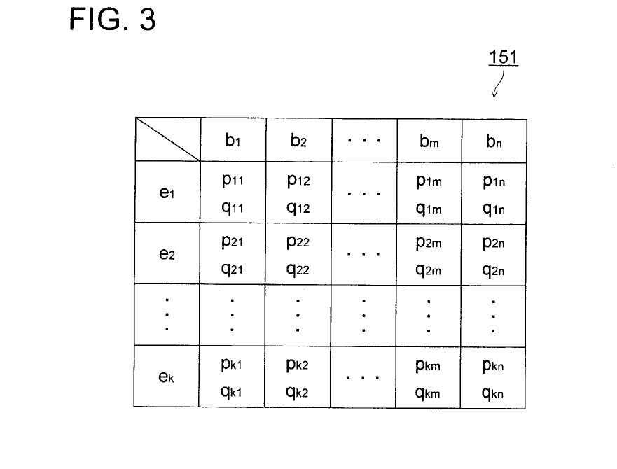

In the present embodiment, the recording medium 15a is structured by having a default parameter table 151 corresponding to the output device and the photographic part. FIG. 3 is a view showing an example of data storage in the default parameter table 151. As shown in FIG. 3, in each line of the default parameter table 151, the processing parameter (for example, “p11, q11”, as the processing parameter corresponding to the output device e1 and photographic part b1, and “p12, q12”, . . . , as the processing parameter corresponding to the output device e1 and photographic part b2) for each photographic part corresponding to the output device (for example, “e1”, “e2”, . . . ) is stored. In the row of the default parameter table 151, the processing parameter (for example, “p11”, q11”, as the processing parameter corresponding to the photographic part b1 and output device e1, and “p21, q21”, . . . , as the processing parameter corresponding to the photographic part b1 and output device e2) for each output device corresponding to the photographic parts (for example, “b1”, “b2”, . . . ) is stored. When the processing parameter stored in the position at which the output device line and photographic part line are crossed, considers the gradation characteristic of the output device and frequency characteristic, and displays (outputs) the image of certain photographic part, the parameter is an image processing parameter set in the default under the assumption that the optimum image processing can be conducted.

The communication control section 16 is structured by the LAN adapter or router, or TA (Terminal Adapter), and conducts the communication control to each apparatus connected to the communication network, for example, the other medical image processing apparatus 1, image collecting apparatus 2, image display apparatus 3, or printer 4.

The image processing section 17 conducts the image processing such as the rotation processing, gradation processing, or frequency processing on the medical image data inputted from the image collecting apparatus 2. Further, it conducts the compression processing which compresses the image data in a predetermined coding format, extending processing which decodes the compressed image data and extends it, format conversion processing into the adopted image format, or conversion processing for displaying on the display section or outputting by the printer.

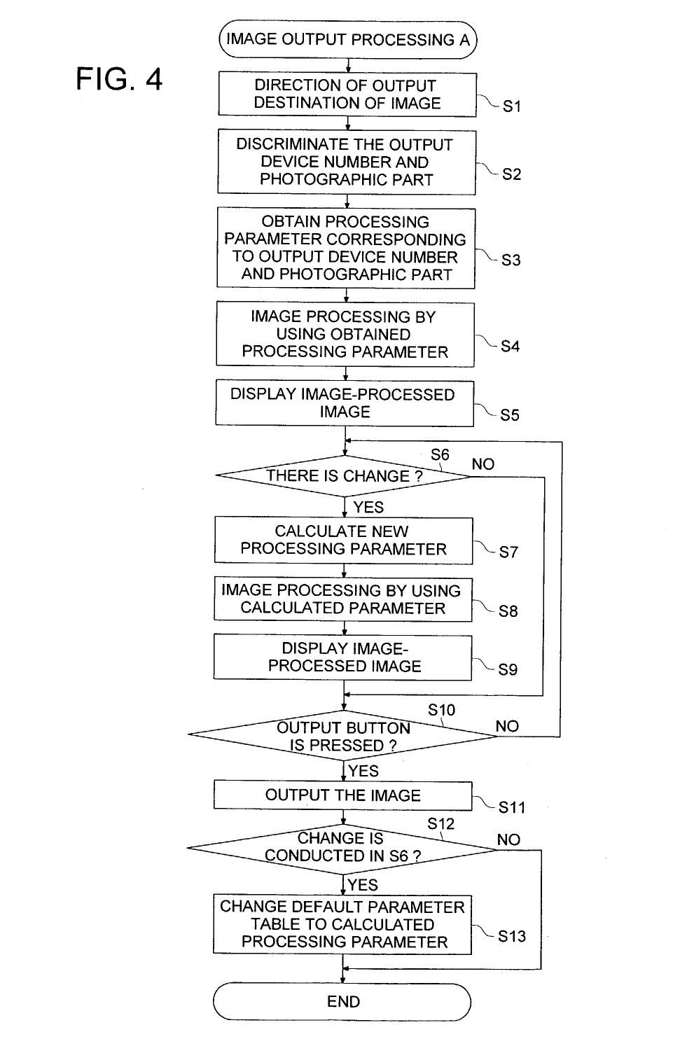

Next, the operation will be described. Referring to the flowchart in FIG. 4, the image output processing A which is conducted by the medical image processing apparatus 1 will be described.

When a button for the output destination is operated by the operation of the mouse or touch operation on the image output operation image plane, and the apparatus of the output destination of the photographed image (medical image) displayed on the image plane is specified (step S1), the CPU 11 discriminates the output device number by the operated button for the designation of output, and refers to the medical image information stored in the storing medium 15a and discriminates the photographic part of the image which is an object of the output (step S2). Next, the CPU 11 refers to the default parameter table 151 and obtains the processing parameter corresponding to the output device number and the photographic part discriminated in step S2 (step S3). For example, when it is discriminated that the output device number is ek, and photographic part is bm, from the default parameter table 151 (refer to FIG. 3), the processing parameters pkm, qkm are obtained. Then, the CPU 11 conducts the image processing on the image which is the object of the output according to the processing parameter obtained in the image processing section 17 (step S4), and displays the image processed image on the image output operation image plane (step S5).

After the image processed image is displayed on the image output operation image plane, the change of the processing parameter is designated, and when the new parameter is inputted (step S6: YES), the CPU 11 calculates the new processing parameter according to the inputted parameter (step S7), conducts the image processing on the image which is the object of the output (step S8), and displays the image processed image on the image output operation image plane (step S9). In step S10, until the output button is pressed, the CPU 11 repeatedly conducts the processing of the step S6-S10. Then, when the output button is pressed and the output of the image is designated (step S10: YES), the CPU 11 outputs the image processed image to the designated output device (step S11).

After the image is outputted, the CPU 11 judges whether the change of the processing parameter is conducted in the step S6, and when it judges that the change of the parameter is not conducted (step 12: NO), the image output processing A is completed. When the CPU 11 judges that the change of the parameter is conducted (step 12: YES), the CPU 11 re-writes the processing parameter in the default parameter table 151 corresponding to the output device and photographic part to the processing parameter calculated in the step S7 (step S13), and completes the image output processing A.

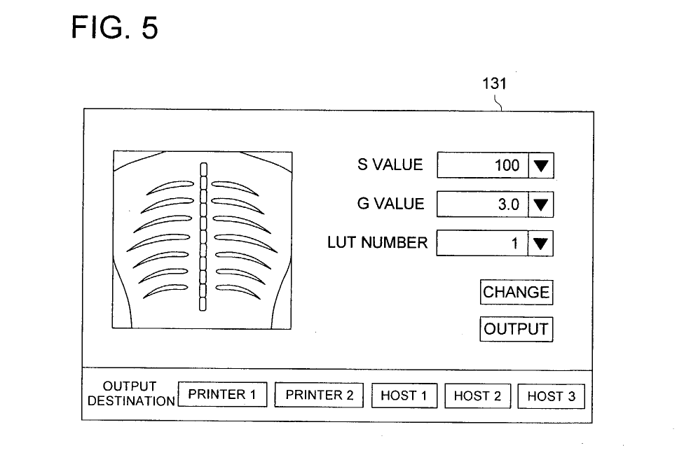

FIG. 5 is a view showing an example of the image output operation image plane 131. As shown in FIG. 5, on the left side of the image plane of the image output operation image plane 131, the photographic image outputted to the outside output device is displayed. On the lower portion of the image plane, the buttons for the output destination such as the “printer 1”, “printer 2”, and “host 1” are displayed, and when the button for the output destination is pressed, the image processing is conducted on the photographic image by the processing parameter corresponding to the output destination, and the image is displayed. Then, the “output“button arranged on the upper portion of the button for the output destination is pressed, the image on which the image processing is conducted is outputted to the output device such as the CRT connected to the designated printer or designated host. On the right side of the image plane, an input space of the parameter is displayed. In step S6 in FIG. 4, the value is selected from the input space of this parameter, and when “change” button is pressed, in the step S7, the processing parameter corresponding to the output destination and photographic part designated in step S1 is calculated according to the inputted numeric value, and in the step S13, the default parameter 151 is re-written.

As described above, according to the medical image processing apparatus 1, the CPU 11 refers to the default parameter table 151 when the output destination of the photographic image is designated, obtains the processing parameter corresponding to the designated output device and the part of the photographic image, conducts the image processing on the photographic image according to the processing parameter, and outputs it to the designated output device. Accordingly, in the system in which a plurality of output devices are connected, in the case where the gradation characteristic of each output device or frequency characteristic is different, when the optimum processing parameter is stored in the default parameter table 151, it is not necessary that the processing parameter is set again every when the image is outputted by the output device, and the image output operation becomes easy.

(The second Embodiment)

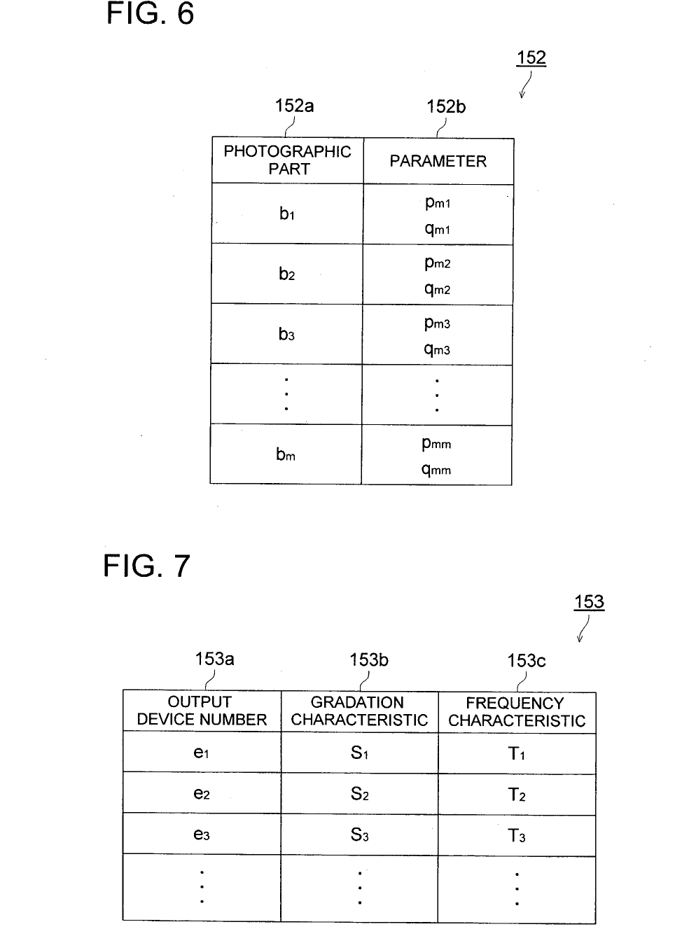

The second embodiment will be described below. In the present embodiment, the recording medium 15a is structured by having the default parameter table 152 and output device characteristic table 153 in the inside. FIG. 6 is a view showing the data storing example of the default parameter table 152 which stores the default processing parameter when the photographic image is displayed in the output device provided in the present medical image processing apparatus 1 by making it correspond to the photographic part. As shown in FIG. 6, the default parameter table 152 has a photographic part area 152a which stores the identification code uniformly allotted for specifying the photographic part (for example, “b1”, “b2”, “b3”. . . . ) as the “photographic part”, and a parameter area 152b which stores the data (for example, “pm1, qm1”, “pm2, qm2”, “pm3, qm3”, . . . ) expressing the corresponding processing parameter as “parameter”.

FIG. 7 is a view showing a data storing example of the output device characteristic table 153 which stores the output device connected to the present medical image processing apparatus 1 and its gradation characteristic and frequency characteristic, by making them correspond to each other. As shown in FIG. 7, the output device characteristic table 153 has an output device number area 153a which stores the identification code (for example, “e1”, “e2”, “e3”, . . . ) uniformly allotted for specifying the output device as “output device number”, gradation characteristic area 153b which stores the data (for example, “S1”, “S2”, “s3”, . . . ) expressing the gradation characteristic corresponding to the output device, as “gradation characteristic”, and frequency characteristic area 153c which stores the data (for example, “T1”, “T2”, “T3”, . . . ) expressing the frequency characteristic corresponding to the output device as “frequency characteristic”.

Further, although it is not specifically shown, the recording medium 15a stores the output characteristic in the output device provided in the present medical image processing apparatus 1 (for example, the frequency characteristic SD, gradation characteristic TD). In this connection, because the structure of the other medical image processing apparatus 1 in the present embodiment is the same as the first embodiment described above, the same numeric code is attached to each component, and the graphic display and explanation of the structure are omitted.

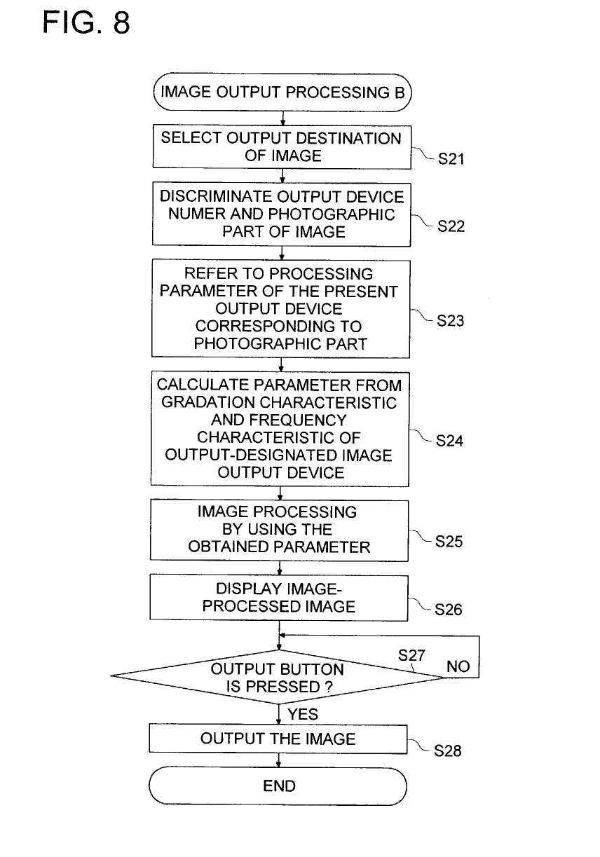

Referring to the flowchart in FIG. 8, the image output processing B conducted by the medical image processing apparatus 1 will be described below. When the output designation button is operated by the operation by the mouse or touch operation on the image output operation image plane and the device of the output destination of the medical image displayed on the image plane is designated (step S21), the CPU 11 discriminates the output device number by the operated output destination button, and refers to the medical image information stored in the recording medium 15a, and discriminates the photographic part of the image which is the object of the output (step S22). Next, the CPU 11 refers to the default parameter table 152 obtains the processing parameter corresponding to the discriminated photographic part in the output device (output device in which the output image is already confirmed, hereinafter, it is described as the present output device) provided in the present medical image processing apparatus 1 (step S23). For example, when the photographic part is discriminated as bm, the processing parameters pmm, qmm are obtained by the default parameter table 152.

Next, the CPU 11 reads the gradation characteristic and frequency characteristic of the designated output device from the output device characteristic table 153, and calculates the processing parameter (step S24). For example, when the image data is outputted from the output device of the output device number e1, the gradation characteristic SD and frequency characteristic T1 of the output device e1 are obtained from the output device characteristic table 153, and when the difference of the gradation characteristics SD and S1 of the present output device is Δs1, and the ratio T1/TD of the frequency characteristics TD and T1 of the present output device is Rt1, the processing parameters pmm+Δs1, and qmm×Rt1, are calculated. Then, the CPU 11 conducts the image processing at the processing parameter pmm+Δs1, and qmm×Rt1 obtained in the image processing section 17 (step S25), and the image processed image is displayed on the image output operation image plane (step S26). When the output button is pressed and the output of the image is designated (step S27; YES), the CPU 11 outputs the image processed image to the designated output device (step S28).

As described above, according to the CPU 11, the processing parameter adjusted for the gradation characteristic and frequency characteristic of the present output device is stored, this processing parameter is referred to, the processing parameter is calculated corresponding to the gradation characteristic and frequency characteristic of the output device of the output destination, and according the calculated processing parameter, the image is image processed and outputted to the output device. Accordingly, the capacity of the memory to store the processing parameter can be suppressed.

In this connection, in the above embodiment, when the processing parameter according to the gradation characteristic and frequency characteristic of the present output device is stored and outputted by the other output device which is the output destination, the processing parameter is calculated corresponding to its the gradation characteristic and frequency characteristic, however, the output characteristic (the gradation characteristic and frequency characteristic) of the reference output device which is a certain reference, and the reference processing parameter in the reference output device are stored, and when the image is outputted to the output device having the other output characteristic, the reference processing parameter is referred to, the processing parameter is calculated corresponding to the gradation characteristic and frequency characteristic of the output device of the output destination, and according to the calculated processing parameter, the image processing is conducted and the image may be outputted to the output device designated as the output destination. Thereby, in a plurality of medical image processing apparatus, the default processing parameter or the characteristic information of the output device can be jointly owned, and the wide use property is increased.

(The third Embodiment)

The third embodiment in which, when the medical image processing apparatus 1 is used by a plurality of operators, the processing parameter is set for each operator, will be described below. In the present embodiment, the recording medium 15a is structured by having the default parameter table 154 in its inside.

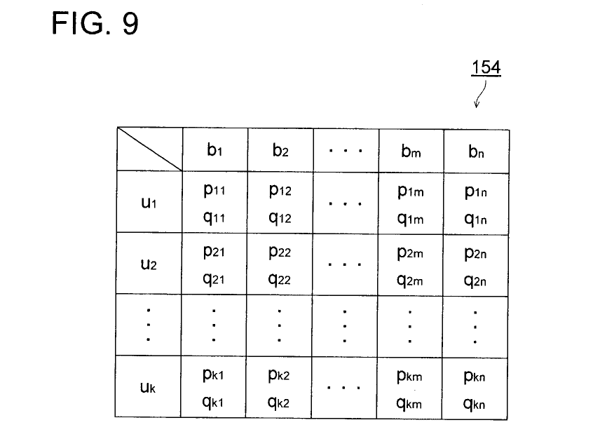

FIG. 9 is a view showing a data storing example in the default parameter table 154. As shown in FIG. 9, in each line of the default parameter table 154, the processing parameter for each photographic part corresponding to the operator (for example, “u1”, “u2”, . . . ) (for example, as the processing parameter corresponding to the operator u1 and photographic part b1, “p11, q11”, and as the processing parameter corresponding to the operator u1 and photographic part b2, “p12, q12”, . . . ), are stored. In each line of the default parameter table 154, the processing parameter for each operator corresponding to the photographic part (for example, “b1”, “b2”, . . . ) (for example, as the processing parameter corresponding to the photographic part b1 and operator u1, “p11, q11”, and as the processing parameter corresponding to the photographic part b1 and operator u2, “p21, q21”, . . . ), are stored. The processing parameter stored in a position at which the operator line and photographic part line cross each other is the processing parameter set in the default under the assumption that the optimum image processing can be conducted when a plan of the operator is considered, and the image of a certain photographic part is displayed (outputted).

In this connection, because the other structure of the medical image processing apparatus 1 in the present embodiment is the same as the above-described first embodiment, the same numeric code is attached to each component, and the graphic display of the component and explanation are omitted.

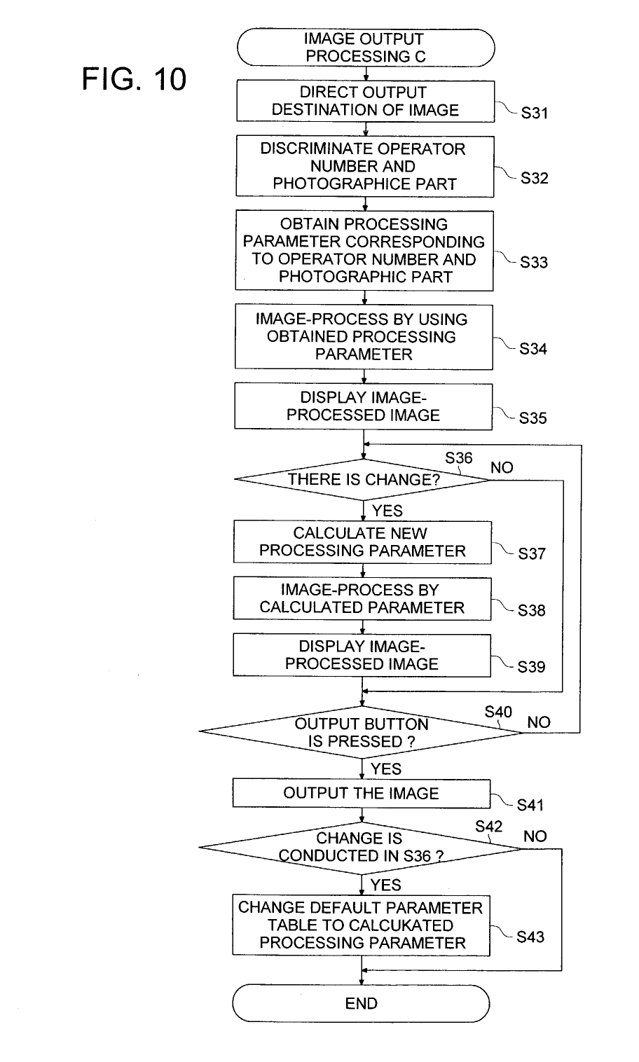

Referring to a flowchart in FIG. 10, the image output processing C conducted by the medical image processing apparatus 1, will be described below.

When the operator (user) is designated by the operation of the muse or touch operation on the image output operation image plane (step S31), the CPU 11 discriminates the operator number of the designated operator, and refers to the medical image information stored in the recording medium 15a, and discriminates the photographic part of the image which is the output object (step S32). Next, the CPU 11 refers to the default parameter table 154, and obtains the processing parameter corresponding to the operator number and photographic part discriminated in step S32 (step S33). For example, when it is discriminated that the operator number is uk and photographic part is bm, from the default parameter table 154 (refer to FIG. 9), the processing parameters pkm and qkm are obtained. Then, the CPU 11 makes the image processing section 17 conduct the image processing on the output object image according to the processing parameter (step S34), and displays the image processed image on the image output operation image plane (step S35).

After the display of the image processed image onto the image output operation image plane, the change of the processing parameter is designated, and when new parameter is inputted (step S36; YES), the CPU 11 calculates the new processing parameter according to the inputted parameter (step S37), and makes the image processing section conduct the image processing on the output object image according to the calculated processing parameter (step S38), and displays the image processed image on the image output operation image plane (step S39). In step S40, until the output button is pressed, the CPU 11 repeatedly conducts the processing of the above steps S36-S40. Then, when the output button is pressed and the output of the image is designated (step S40; YES), the CPU 11 outputs the image processed image to the output device (step S41).

After the image is outputted, the CPU judges whether the change of the processing parameter is conducted in step S36, and when it is judged that the change of the processing parameter is not conducted (step S42; NO), the image output processing C is completed. When it is judged that the change of the processing parameter is conducted (step S42; YES), the CPU 11 re-rewrites the processing parameter in the default parameter table 154 corresponding to the operator number and photographic part to the processing parameter calculated in step S37 (step S43), and the image output processing C is completed.

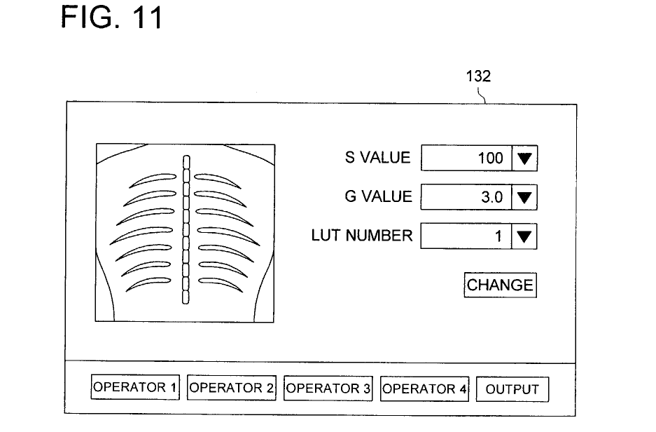

FIG. 11 is a view showing an example of the image output operation image plane 132. As shown in FIG. 11, on the left side of the image plane of the image output operation image plane, the photographic image to be outputted to the other output destination is displayed. On the lower portion of the image plane, the operator direction button such as “operator 1”, “operator 2” and “operator 3” is displayed, and when this operator direction button is pressed, the image processing is conducted on the photographic image with the processing parameter corresponding to the designated operator and the image is displayed, and when the “output” button is pressed, the processed image is outputted to the output device. On the right side of the image plane, the input space of the parameter is displayed. In the step S36 in FIG. 10, the numerical value is selected from the input area of this parameter, and when “change” button is pressed, in the step S37, according to the inputted numerical value, the processing parameter corresponding to the operator designated in the step S31 and the photographic part of the image is calculated, and re-written in the step S43.

As described above, according to the medical image processing apparatus 1, when the operator is designated, the CPU 11 refers to the default parameter table 154, and obtains the processing parameter corresponding to the designated operator and part of the photographic image, and according to the processing parameter, conducts the image processing on the photographic image and outputs it to the output device. Accordingly, even when a plurality of operators use the same output device, when the default processing parameter is stored for each operator, it is not necessary that the desired processing parameter is set again every when the image is outputted by the output device, and the image output operation becomes easy.

In this connection, the description of the fourth embodiment is a preferred example according to the present invention, and the present invention is not limited to this description.

For example, in the above embodiment, the operator is specified by pressing the operator direction button from the operation image plane, but it is not limited to this, for example, in the case where the user ID is inputted when the medical image processing apparatus 1 is used, from this user ID, the operator is discriminated, and the image processing may also be conducted with the corresponding processing parameter.

Further, in the first-third embodiments, the processing parameter and the calculation method of the processing parameter are an example, and are not limited to this.

Further, the first-third embodiments are separately described, but the function of the first-third embodiments may also be jointly owned. Other then that, relating also to the detailed structure of the medical image processing apparatus 1 and the movement of the detailed portion, they can be appropriately changed within the scope not departed from the spirit of the present invention.

In the above examples, it is characteristic that mainly two different elements are focused as conditions and used to decide the processing parameters. However, the present invention is possible to be applied to the other configuration in which three different elements are used to decide the processing parameters.

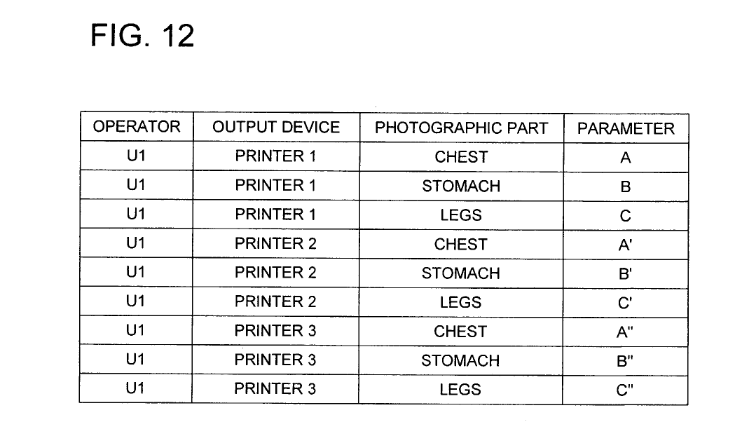

For example in FIG. 12, the three conditions of operators, output devices and photographic parts are used to decide the processing parameters. In this case, for the same operator U1, there are three different types of printers 1 through 3 and three different photographic parts of chest, stomach and legs are provided for the conditions so that the total of nine processing parameters are preset to the apparatus. For this example, the methods to call out the processing parameters from the apparatus and to setting the parameters in the apparatus are assumed to be the same as those of aforementioned examples.

According to the present invention, the image processing parameter corresponding to each photographic part of the medical image and for each output device to output the processed image is stored in the storing means, and the photographic part of the obtained medical image and the output device of the output destination are discriminated, and the image processing parameter corresponding to the discriminated photographic part and output device are read from the storing means, and according to the read image processing parameter, the image processing is conducted on the obtained medical image and the image is outputted to the output device. Accordingly, in the case of the system in which a plurality of output devices are connected, every when the image is outputted by the output device, it is not necessary that the image processing parameter is set again, and the image output operation becomes easy.

Further, according to the present invention, together with the image output characteristic of the output device whose output image is already confirmed, the image processing parameter for each photographic part of the medical image corresponding to the output device are stored in the storing means, and when the processed image is outputted to the other output device different from the above-described output device, the image processing parameter stored in the storing means is corrected adjusting to the image output characteristic of the other output device, and according to the corrected image processing parameter, the image processing is conducted on the obtained medical image. Accordingly, in the case of the system in which a plurality of output devices are connected, every when the image is outputted by the output device, it is not necessary that the image processing parameter is set again, and the image output operation becomes easy. Further, the capacity to store the processing parameter can be suppressed.

According to the present invention, together with the image output characteristic of the standard output device, the standard image processing parameter for each photographic part of the medical image corresponding to the output device are stored in the storing means, and when the processed image is outputted to the output device different from the standard output device, the standard image processing parameter stored in the storing means is corrected adjusting to the image output characteristic of the output device to output it, and according to the corrected image processing parameter, the image processing is conducted on the obtained medial image. Accordingly, in the case of the system in which a plurality of output devices are connected, every when the image is outputted by the output device, it is not necessary that the image processing parameter is set again, and the image output operation becomes easy. Further, the capacity to store the image processing parameter can be suppressed, and in a plurality of medical image processing apparatus, the image processing parameter stored in the storing means or the characteristic information of each output device can be owned jointly.

According to the present invention, the image processing parameter corresponding to each photographic part of the medical image and for each operator is stored in the storing means, the photographic part of the obtained medical image and operator are discriminated, and the image processing parameter corresponding to the discriminated photographic part and operator is read from the storing means, and according to the read image processing parameter, the image processing is conducted on the obtained medical image, and the image is outputted to the output device. Accordingly, even when a plurality of operators use the same output device, every when the image is outputted by the output device, it is not necessary that the parameter is set again to the image processing parameter matched with the plan, and the image output operation becomes easy.

What is claimed is:

1. A medical image processing apparatus, in a medical image processing system including a plurality of output apparatus in a same network, for obtaining and processing a photographed medical image so as to output a processed image, comprising:
a storing means for storing an image processing parameter corresponding to each photographic part of a medical image and to each output device for outputting said processed image;
a discriminating means for discriminating a photographic part of an obtained medical image and a selected one of said output device; and
an image processing means for reading out said image processing parameter from said storing means, corresponding to said photographic part and said selected one of said output device, discriminated by said discriminating means;
wherein said image processing means performs image processing on said obtained medical image according to said image processing parameter so as to generate said processed image; and said image processing means outputs said processed image to said selected one of said output device.

2. The medical image processing apparatus of claim 1,
wherein said storing means stores said image processing parameter for each photographic part of said medical image corresponding to said selected one of output device, with an image output characteristic of said selected one of said output device;
said image processing means, when said processed image is outputted to another output device, corrects said image processing parameter, stored in said storing means, by adjusting to said image output characteristic of said another output device; and
said image processing means conducts image processing on said obtained medical image according to said image processing parameter adjusted by said image processing means.

3. The medical image processing apparatus of claim 1,
wherein said storing means stores a standard image processing parameter for each photographic part of said medical image corresponding to a standard output device, with an image output characteristic of said standard output device;
said image processing means corrects said standard image processing parameter, stored in said storing means, by adjusting to an image output characteristic of said output device when said processed image is outputted to said output device which is different from said standard output device; and
said image processing means conducts image processing on said obtained medical image according to said image processing parameter adjusted by said image processing means.

4. A medical image processing apparatus, in a medical image processing system including a plurality of output apparatus in a same network, for obtaining and processing a photographed medical image so as to output a processed image, comprising:
a storing means for storing an image processing parameter corresponding to each photographic part of a medical image and to each of an operator;
a discriminating means for discriminating a photographic part of an obtained medical image and said operator; and
an image processing means for reading out said image processing parameter from said storing means, corresponding to said photographic part and operator discriminated by said discrimination means;
wherein said image processing means performs image processing on said obtained medical image according to said image processing parameter so as to generate said processed image; and said image processing means outputs said processed image to said output device.

5. A medical image processing apparatus, in a medical image processing system including a plurality of output apparatus in a same network, for obtaining and processing a photographed medical image so as to output a processed image, comprising:
a storing means for storing an image processing parameter corresponding to each photographic part of a medical image, to each of an operator and to each of output device;
a discriminating means for discriminating a photographic part of an obtained medical image, said operator and a selected one of said output device; and
an image processing means for reading out said image processing parameter from said storing means, corresponding to said photographic part, said operator and said selected one of said output device, discriminated by said discrimination means;
wherein said image processing means performs image processing on said obtained medical image according to said image processing parameter so as to generate said processed image; and said image processing means outputs said processed image to said selected one of said output device.

6. A medical image processing method, in a medical image processing system including a plurality of output apparatus in a same network, for obtaining and processing a photographed medical image so as to output a processed image, comprising the steps of:
storing an image processing parameter, corresponding to each photographic part of a medical image and to each output device for outputting said processed image, to a storing means;
discriminating a photographic part of an obtained medical image and a selected one of said output device;
reading out said image processing parameter from said storing means, corresponding to said photographic part and said selected one of said output device, discriminated by said discriminating step;
performing image processing on said obtained medical image according to said image processing parameter so as to generate said processed image; and
outputting said processed image to said selected one of said output device.

7. A medical image processing method, in a medical image processing system including a plurality of output apparatus in a same network, for obtaining and processing a photographed medical image so as to output a processed image, comprising the steps of:
storing an image processing parameter, corresponding to each photographic part of a medical image and to each of an operator, to a storing means;
discriminating a photographic part of an obtained medical image and said operator;
reading out said image processing parameter from said storing means, corresponding to said photographic part and operator discriminated by said discrimination step;
performing image processing on said obtained medical image according to said image processing parameter so as to generate said processed image; and
outputting said processed image to said output device.

8. A medical image processing method, in a medical image processing system including a plurality of output apparatus in a same network, for obtaining and processing a photographed medical image so as to output a processed image, comprising the steps of:
storing an image processing parameter, corresponding to each photographic part of a medical image, to each of an operator and to each of output device, to a storing means;
discriminating a photographic part of an obtained medical image, said operator and said output device;
reading out said image processing parameter from said storing means, corresponding to said photographic part, said operator and said output device, discriminated by said discrimination step;
performing image processing on said obtained medical image according to said image processing parameter so as to generate said processed image; and
outputting said processed image to said output device.

9. A medical image processing program, working with a computer in a medical image processing system including a plurality of output apparatus in a same network, for obtaining and processing a photographed medical image so as to output a processed image, comprising the steps of:
storing an image processing parameter, corresponding to each photographic part of a medical image and to each output device for outputting said processed image, to a storing means;
discriminating a photographic part of an obtained medical image and a selected one of said output device;
reading out said image processing parameter from said storing means, corresponding to said photographic part and said selected one of said output device, discriminated by said discriminating step;
performing image processing on said obtained medical image according to said image processing parameter so as to generate said processed image; and
outputting said processed image to said selected one of said output device.

10. A medical image processing program, working with a computer in a medical image processing system including a plurality of output apparatus in a same network, for obtaining and image-processing a photographed medical image so as to output a processed image, comprising the steps of:
storing an image processing parameter, corresponding to each photographic part of a medical image and to each of an operator, to a storing means;
discriminating a photographic part of an obtained medical image and said operator;
reading out said image processing parameter from said storing means, corresponding to said photographic part and operator discriminated by said discrimination step;
performing image processing on said obtained medical image according to said image processing parameter so as to generate said processed image; and
outputting said processed image to said output device.

11. A medical image processing program, working with a computer in a medical image processing system including a plurality of output apparatus in a same network, for obtaining and processing a photographed medical image so as to output a processed image, comprising the steps of:
storing an image processing parameter, corresponding to each photographic part of a medical image, to each of an operator and to each of output device, to a storing means;
discriminating a photographic part of an obtained medical image, said operator and a selected one of said output device;
reading out said image processing parameter from said storing means, corresponding to said photographic part, said operator and said selected one of said output device, discriminated by said discrimination step;
performing image processing on said obtained medical image according to said image processing parameter so as to generate said processed image; and
outputting said processed image to said selected one of said output device.

12. A media for storing a medical image processing program, working with a computer in a medical image processing system including a plurality of output apparatus in a same network, for obtaining and processing a photographed medical image so as to output a processed image, wherein said medical image processing program comprises the steps of:
storing an image processing parameter, corresponding to each photographic part of a medical image and to each output device for outputting said processed image, to a storing means;
discriminating a photographic part of an obtained medical image and a selected one of said output device;
reading out said image processing parameter from said storing means, corresponding to said photographic part and said selected one of said output device, discriminated by said discriminating step;
performing image processing on said obtained medical image according to said image processing parameter so as to generate said processed image; and
outputting said processed image to said selected one of said output device.

13. A media for storing a medical image processing program, working with a computer in a medical image processing system including a plurality of output apparatus in a same network, for obtaining and processing a photographed medical image so as to output a processed image, wherein said medical image processing program comprises the steps of:
storing an image processing parameter, corresponding to each photographic part of a medical image and to each of an operator, to a storing means;
discriminating a photographic part of an obtained medical image and said operator;
reading out said image processing parameter from said storing means, corresponding to said photographic part and operator discriminated by said discrimination step;
performing image processing on said obtained medical image according to said image processing parameter so as to generate said processed image; and
outputting said processed image to said output device.

14. A media for storing a medical image processing program, working with a computer in a medical image processing system including a plurality of output apparatus in a same network, for obtaining and processing a photographed medical image so as to output a processed image, wherein said medical image processing program comprises the steps of:
storing an image processing parameter, corresponding to each photographic part of a medical image, to each of an operator and to each of output device, to a storing means;
discriminating a photographic part of an obtained medical image, said operator and a selected one of said output device;
reading out said image processing parameter from said storing means, corresponding to said photographic part, said operator and said selected one of said output device, discriminated by said discrimination step;
performing image processing on said obtained medical image according to said image processing parameter so as to generated said processed image; and
outputting said processed image to said selected one of said output device.
